(19) United States
(12) Patent Application Publication
(10) Pub. No.: US 2026/0219043 A1
(43) Pub. Date: Jul. 30, 2026

(54) MEMS SENSOR COMPONENT AND ROTATION RATE SENSOR

(71) Applicant: Robert Bosch GmbH, Stuttgart (DE)

(72) Inventors: Joerg Martin Schumacher, Stuttgart (DE); Kevin Haeuser, Reutlingen (DE); Manuel Glueck, St. Johann (DE); Robert Ramsperger, Haigerloch (DE)

(21) Appl. No.: 19/449,701

(22) Filed: Jan. 15, 2026

(30) Foreign Application Priority Data
Jan. 28, 2025 (DE) 10 2025 102 926.1

(51) Int. Cl. G01C 19/5712; G01C 19/5776

(52) U.S. Cl. CPC G01C 19/5712; G01C 19/5776

(57) ABSTRACT

A MEMS sensor component. The MEMS sensor component includes a substrate with a substrate surface, a first rotor mass, and two first drive elements which are connected to the first rotor mass via first drive coupling structures and are configured to set the first rotor mass into a first rotational oscillating movement about a first axis of rotation oriented perpendicular to the substrate surface. The first rotor mass and/or the first drive coupling structures are designed to promote a first tilting movement of the first rotor mass about a first tilt axis oriented parallel to the substrate surface, and to suppress a second tilting movement of the first rotor mass about a second tilt axis oriented perpendicular to the first tilt axis when a rotation rate is applied to the MEMS sensor component. A rotation rate sensor including a MEMS sensor component is also described.

### FIELD

The present disclosure relates to a MEMS sensor component and a rotation rate sensor.

### BACKGROUND INFORMATION

Certain MEMS sensor components are described in the related art. The abbreviation MEMS stands for microelectromechanical systems, the microstructural properties and suitable manufacturing processes of which enable the miniaturization of electromechanical functional components such as actuators and sensors.

Germany Patent Application No. DE 10 2020 205 372 A1 describes a micromechanical component for a rotation rate sensor comprising a substrate with a substrate surface, a one-piece first rotor mass which can be set into a first rotational oscillating movement about a first axis of rotation oriented perpendicular to the substrate surface, and at least one first component of the micromechanical component, wherein the first rotor mass is connected to the at least one first component via at least one first spring element, wherein the at least one first spring element extends through a respective lateral indentation on the first rotor mass and is connected to a recessed edge region of the first rotor mass.

### SUMMARY

According to certain features of the present disclosure, a MEMS sensor component is provided. According to an example embodiment, the MEMS sensor component includes a substrate with a substrate surface, a first rotor mass, and two first drive elements which are connected to the first rotor mass via first drive coupling structures and are configured to set the first rotor mass into a first rotational oscillating movement about a first axis of rotation oriented perpendicular to the substrate surface. The first rotor mass and/or the first drive coupling structures are designed to promote a first tilting movement of the first rotor mass about a first tilt axis oriented parallel to the substrate surface, and to suppress a second tilting movement of the first rotor mass about a second tilt axis oriented perpendicular to the first tilt axis when a rotation rate is applied to the MEMS sensor component. In other words, the idea is to use the structural design of the rotor mass and/or the drive coupling structures to achieve different direction-dependent tilting mobilities of the first rotor mass, in particular to achieve a higher tilting mobility of the rotor mass about the first tilt axis than about the second tilt axis. This makes it possible to restrict the degrees of freedom of movement of the first rotor mass at least approximately such that rotation rate acquisition using the MEMS sensor component is selectively limited to one detection axis. In accordance with the proposed features, the MEMS sensor component has the advantage of having a particularly robust sensor structure with a vibration sensitivity that is significantly reduced compared to structurally comparable multi-axis sensor structures. The MEMS sensor component is thus suitable, among other things, for applications in environments with high linear and rotational accelerations in which application has previously not been possible or possible only with the use of special dampers.

According to one example embodiment, the MEMS sensor component can further comprise a second rotor mass and two second drive elements which are connected to the second rotor mass via second drive coupling structures and are configured to set the second rotor mass into a second rotational oscillating movement about a second axis of rotation oriented perpendicular to the substrate surface. The second rotor mass and/or the second drive coupling structures are designed to promote a third tilting movement of the second rotor mass about a third tilt axis oriented parallel to the substrate surface, and to suppress a fourth tilting movement of the second rotor mass about a fourth tilt axis oriented perpendicular to the third tilt axis when a rotation rate is applied to the MEMS sensor component. The use of two rotor masses, which in particular carry out oppositely directed rotational oscillating movements and can therefore be tilted in opposite directions about the first and the third tilt axis, enables a differential evaluation of the detected tilting movements. External influences affect both rotor masses equally and can be canceled out via signals, so that the second rotor mass is provided an advantageous compensation function. This makes it possible to significantly increase the measurement accuracy of the MEMS sensor component. The first rotor mass and the second rotor mass can both be formed in one piece. The third tilt axis can be parallel to the first tilt axis.

The first and second drive elements of the MEMS sensor component can be configured to set the first and the second rotor mass into rotational oscillating movements about axes of rotation oriented perpendicular to the substrate surface. The first and second drive elements can in particular be configured to set the first and the second rotor mass into oppositely directed rotational oscillating movements. The first and second drive elements can be driven with a suitable phase offset, for instance. The first and second drive elements can be moved translationally parallel to the substrate surface, wherein an oppositely directed translational movement of the first drive elements via the first drive coupling structures is converted into a rotational movement of the first rotor mass and an oppositely directed translational movement of the second drive elements via the second drive coupling structures is converted into a rotational movement of the second rotor mass. Coriolis forces enable the rotational oscillating movements to set the rotor masses into a detectable tilting movement when a rotation rate is applied to the MEMS sensor component. The first and/or the second drive elements can each be connected to the substrate via a deflecting spring with direction-dependent different effective spring stiffnesses. The deflecting spring can in particular be configured, for example specially shaped, such that there is a high degree of mobility of the connected drive element parallel to the second or the fourth tilt axis and a relatively lower degree of mobility of the drive element parallel to the first or the third tilt axis. The deflecting spring can also be designed to reduce the tilting mobility of the connected drive element. A deflecting spring according to the above-described features makes it possible to achieve a defined translational movement of the connected drive element, which contributes to selectively limiting the rotation rate acquisition by means of the MEMS sensor component to one detection axis. The deflecting spring can have a meander shape, for instance, and can be attached to an anchor element connected to the substrate.

To facilitate understanding, the axes of rotation and the tilt axes can then be assigned to spatial directions of a three-dimensional coordinate system. For the sake of simplicity, it can, for instance, be specified that the second and the fourth tilt axis extend along an x-direction the first and the third tilt axis extend along a y-direction, and the first and the second axis of rotation extend along a z-direction of the coordinate system. The MEMS sensor component can be configured to detect a rotation rate being applied to the MEMS sensor component about the x-axis by means of the first tilting movement of the first rotor mass and the third tilting movement of the second rotor mass about the first and the third tilt axis extending in y-direction, while, due to the structurally suppressed tilting movement about the second and the fourth tilt axis along the x-direction, a rotation rate being applied to the MEMS sensor component about the y-axis has a negligible effect on the rotor masses.

According to an example embodiment, a MEMS sensor component can be a semiconductor-based component comprising mechanical and electrical microstructures, for example, that is suitable for implementation as a system-on-chip (SoC). The MEMS sensor component described in this application is in particular configured for direction-dependent acquisition of rotation rates and for use in a rotation rate sensor. The substrate of the MEMS sensor component can be a flat semiconductor carrier structure; for example a silicon wafer. The substrate comprises two oppositely disposed substrate surfaces, which can be referred to as the front side and the rear side. The front side of the substrate can form an active side of the substrate on which the mechanical microstructures of the MEMS sensor component are disposed.

The first rotor mass and/or the first drive coupling structures, as well as optionally the second rotor mass and/or the second drive coupling structures, are designed as described above to promote or suppress a tilting movement of the rotor masses about predefined tilt axes. Ideally, it can be assumed that a promoted tilting movement corresponds to a mechanically permitted tilting movement and a suppressed tilting movement corresponds to a mechanically blocked tilting movement. In other words, for example due to their shape and/or due to a special design of the drive coupling structures, the rotor masses exhibit different tilting mobilities about different perpendicularly oriented spatial axes. The degrees of freedom of the rotor masses are in particular reduced such that only tilting movements of the first rotor mass about the first tilt axis, and optionally tilting movements of the second rotor mass about the third tilt axis, lead to relevant measurement signals. This makes the MEMS sensor component very robust to linear and rotational secondary accelerations, for example vibrations and shocks, which can impair precise acquisition of the direction-dependent rotation rate to be detected. The restriction of movement reduces the number of possible paths of action leading to vibration sensitivity of the sensor signal. The mode density of excitation oscillations of the MEMS sensor component can be significantly reduced as well. Excitable oscillation modes of the MEMS sensor component are at significantly higher frequencies and are less excitable. The proposed MEMS sensor component in particular shows itself to be largely insensitive to excitations at specific frequencies that cause a parallel drive mode on the drive elements. In such a parallel drive mode, external oscillations excite the drive elements to a rectified oscillating motion, which can lead to interference signals from the MEMS sensor component.

According to an example embodiment, to detect the first and optionally the third tilting movement of the first and the second rotor mass, the MEMS sensor component can comprise a sensor structure that can be based on an electrostatic or piezoelectric acquisition principle, for instance. It is therefore possible that electrodes assigned to the rotor masses are disposed on the substrate surface and enable capacitive acquisition of the tilting movements of the rotor masses. The electrode arrangement can be tailored to the single-axis detection principle. The electrodes can have a recess below and/or above a rotor suspension of the first rotor mass and/or the second rotor mass.

Despite the high measurement accuracy that can be achieved, the proposed MEMS sensor component has a comparatively simple design with few movable structures, which makes it possible to significantly reduce the vibration sensitivity and the mode density of the MEMS sensor component.

According to one example embodiment, the MEMS sensor component can further comprise a rotor coupling structure for mechanically coupling the first rotor mass to the second rotor mass. The rotor coupling structure mechanically couples the first and the second rotor mass in such a way that manufacturing-related differences in the mobility of the rotor masses can be balanced and more accurate measurement results can be expected. The rotor coupling structure can comprise a first rotor spring bar disposed on the first rotor mass and a second rotor spring bar disposed on the second rotor mass, wherein the first rotor spring bar and the second rotor spring bar are connected to one another by a rotor spring. It is possible to design the rotor coupling structure such that is has direction-dependent different effective spring stiffnesses, for example via a special shape or via a suitable length and width ratio of the rotor spring bars and the rotor spring, such that, when a rotation rate is applied to the MEMS sensor component, the first tilting movement of the first rotor mass and the third tilting movement of the second rotor mass are promoted, and the second tilting movement of the first rotor mass and the fourth tilting movement of the second rotor mass are suppressed. This design of the rotor coupling structure makes it possible to additionally influence the direction-dependent mobility of the rotor masses. The rotor spring bars can have a main extension along the y-direction, for example, i.e. extend substantially perpendicular to the detection axis of rotation of the MEMS sensor component and parallel to the first and the third tilt axis. The first and the second rotor spring bar can extend parallel to one another. The first and the second rotor spring bar can have the same shape and dimensions. The rotor spring can be an elastically deflectable torsion spring which extends in a web-like manner between the first and the second rotor spring bar, for example. The rotor spring can be attached centrally to the rotor spring bar, for instance. The rotor spring can have a main extension along the x-direction. According to one possible embodiment, the MEMS sensor component can have a mirror-symmetrical structure with respect to an axis of symmetry that extends parallel to the first and the third tilt axis through the rotor coupling structure. As a result, external influences affect both rotor masses equally and can be canceled out via signals, so that the second rotor mass is provided an advantageous compensation function. The measurement accuracy of the MEMS sensor component can thus be increased significantly. Due to the mirror-symmetrical structure, the coupled rotor masses are difficult to excite by external linear or rotational accelerations.

According to one example embodiment, the first rotor mass can have a mass distribution such that the first rotor mass has a greater moment of inertia during the first tilting movement than during the second tilting movement. Alternatively or additionally, the second rotor mass can have a mass distribution such that the second rotor mass has a greater moment of inertia during the third tilting movement than during the fourth tilting movement. This provides a simple way to promote or suppress a tilting movement of the rotor masses in a direction-dependent manner via the design of the rotor masses. The mass distribution of the rotor masses can be influenced by a suitable shape in terms of their outer contour, for example, or by material recesses, for instance in the form of perforations or recesses in the sense of larger contiguous through-openings. For example, it is possible to configure the first and/or the second rotor mass to be substantially H-shaped in order to implement a direction-dependent different mass distribution with a predefined preferred tilting direction.

According to one example embodiment, the first rotor mass can comprise a recess which is disposed closer to a first drive coupling structure than to the first axis of rotation.

Alternatively or additionally, the second rotor mass can comprise a recess which is disposed closer to a second drive coupling structure than to the second axis of rotation. This makes it possible to easily influence the mass distribution and the resulting moment of inertia of the rotor mass which differs for the first and the second tilt axis or for the third and the fourth tilt axis. The recess can be positioned such that the first tilt axis or the third tilt axis passes through the recess, i.e. intersects it. The respective mentioned tilt axis can in particular intersect the recess centrally, i.e. bisect it. Because of the recess, viewed from the axis of rotation, a mass of the rotor mass can be smaller in y-direction than in x-direction. Because of its arrangement close to the drive coupling structure, the recess is also located far away from the second or the fourth tilt axis, so that the remainder of the mass is disposed closer to the second or the fourth tilt axis which results in a lower moment of inertia around this axis. The recess can be a through-opening with a closed recess contour. The recess can be positioned in an edge region of the rotor mass and can, for example, be delimited by an edge web on an outer contour of the rotor mass. Viewed in x-direction, for example, the recess can have a width of at least 10%, in particular at least 20%, of the total width of the rotor mass. Viewed in y-direction, for example, the recess can have a length of at least 10%, in particular at least 20%, of the total length of the rotor mass. Since the tilting movements can be acquired by means of the sensor structure in an outer region of the rotor mass away from the recess region, the recess does not lead to a significant loss of sensitivity of the MEMS sensor component.

According to one example embodiment, the first rotor mass can comprise at least two recesses which are disposed mirror-symmetrically with respect to the second tilt axis. Alternatively or additionally, the second rotor mass can comprise at least two recesses which are disposed mirror-symmetrically with respect to the fourth tilt axis. A second, mirror-symmetrically positioned recess makes it possible to achieve a further local reduction in mass and a balanced rotational oscillation and tilting behavior of the rotor mass under consideration. It is also possible to provide more than two recesses in the respective rotor mass.

According to one example embodiment, a stop element can extend through a recess in the first rotor mass or in the second rotor mass parallel to the first axis of rotation of the first rotor mass and/or parallel to the second axis of rotation of the second rotor mass. If there are multiple recesses in the rotor mass under consideration, a stop element can in particular extend through each recess. A mechanically effective stop element can advantageously limit the rotational oscillating movement of the rotor mass under consideration and prevent excessive rotation of the rotor mass that would mechanically overload the drive coupling structures and/or the rotor coupling structure. This advantageously utilizes the installation space in the MEMS sensor component that has been freed up by the recess. The stop element can be anchored to the substrate of the MEMS sensor component. If the MEMS sensor component has a cap structure as a cover, for example in the form of a cap wafer, the stop element can advantageously extend continuously between the substrate and the cap structure and thereby assume a support function for the vertical stabilization of the MEMS sensor component.

According to one example embodiment, the first drive coupling structures and/or the second drive coupling structures can comprise a spring structure with a direction-dependent different effective spring stiffness. The drive coupling structures can thus easily be designed to achieve direction-dependent different tilting mobility of the rotor masses. The spring structure can have a special geometric shape and/or a special orientation, for example, that results in a lower spring stiffness in a first spatial direction than in a second spatial direction.

According to one example embodiment, the first drive coupling structures can comprise first drive spring bars which are disposed on the first drive elements and are connected to the first rotor mass via a drive spring. Alternatively or additionally, the second drive coupling structures can comprise second drive spring bars which are disposed on the second drive elements and are connected to the second rotor mass via a drive spring. This makes it possible to easily provide a spring structure with a direction-dependent different effective spring stiffness, wherein the drive spring bars can exert a stiffening effect to reduce a tilting mobility of the rotor mass under consideration about the second or the fourth tilt axis and wherein the drive spring promotes a comparatively increased tilting mobility of the rotor mass under consideration about the first or the third tilt axis. The restriction of the mobility of the rotor masses can thus be supported in the desired manner and the vibration sensitivity of the MEMS sensor component can be further reduced. The drive spring bars can have a main extension along the x-direction, for example, i.e. extend substantially parallel to the detection axis of rotation of the MEMS sensor component and perpendicular to the first and the third tilt axis. The drive spring can in particular extend predominantly along the y-direction, i.e. parallel to or along the first or the third tilt axis. The drive spring can in particular be configured as an elastically deflectable torsion spring which extends in a web-like manner between a drive spring bar and the rotor mass, for example. The drive spring can be connected to an outer contour of the rotor mass under consideration, for example to an edge web that delimits a recess in the rotor mass.

According to one possible embodiment, viewed in x-direction, the first or the second drive spring bar can be at least as wide as such a recess.

According to one example embodiment, the first rotor mass and the second rotor mass can be mounted one behind the other along a first spatial direction and the first and the third tilt axis can extend perpendicular to the first spatial direction and parallel to the substrate surface. The first and the third tilt axis, about which a tilting movement of the rotor masses is promoted, i.e. mechanically permitted, can extend transverse to the direction in which the two rotor masses are mounted one behind the other. This creates a compact and robust arrangement of the rotor masses, the drive coupling structures and the rotor coupling structure with a selectively restricted mobility of the rotor masses and a favorable mechanical coupling. The first rotor mass and the second rotor mass can be disposed next to one another viewed along the first spatial direction. A first drive element and a second drive element can likewise be disposed next to one another viewed along the first spatial direction. The first spatial direction can be assigned to the x-axis of the above-described coordinate system.

According to one example embodiment, the first drive elements and the first rotor mass can be mounted one behind the other along a second spatial direction and the second drive elements and the second rotor mass can be mounted one behind the other along the second spatial direction, wherein the second spatial direction extends perpendicular to the first spatial direction and parallel to the substrate surface. This creates a compact and robust arrangement of the rotor masses, the drive coupling structures and the rotor coupling structure with a selectively restricted mobility of the rotor masses and a favorable mechanical coupling. The respective first and second drive elements and rotor masses can be disposed next to one another along the second spatial direction, wherein the first rotor mass is disposed between the first drive elements and the second rotor mass is disposed between the second drive elements. In other words, the first drive elements are disposed on two opposite sides of the first rotor mass and the second drive elements are disposed on two opposite sides of the second rotor mass. The second spatial direction can be assigned to the y-axis of the above-described coordinate system.

According to one example embodiment, the first rotor mass and/or the second rotor mass can have a maximum extent in the second spatial direction that corresponds to at least 75% of a maximum extent of the same rotor mass in the first spatial direction.

The rotor mass under consideration can, in simplified terms, have an approximately square basic shape, for example. This makes it possible to increase the mechanical stability of the rotor mass.

According to one example embodiment, the first rotor mass and/or the second rotor mass can have a maximum extent in the second spatial direction that corresponds to at most 75% of a maximum extent of the same rotor mass in the first spatial direction.

The rotor mass under consideration can, in simplified terms, have an approximately rectangular basic shape, for example. This makes it possible to advantageously influence the moment of inertia of the rotor mass under consideration such that the first or the third tilting movement is promoted and the second or the fourth tilting movement is suppressed. The rotor masses shaped in this way also enable a narrower and therefore more compact design of the MEMS sensor component.

According to one example embodiment, the MEMS sensor component can be configured to detect a rotation rate being applied to the MEMS sensor component about a detection axis and the number of detection axes of the MEMS sensor component can be structurally limited to exactly one detection axis. The exactly one detection axis can correspond to the x-direction of the above-described coordinate system. In other words, in the proposed MEMS sensor component, aside from the suppressed tilting movement about the x-axis when a rotation rate is applied about the y-axis, an arrangement of additional sensing elements for detecting rotation rates about the z-axis, i.e. about the above-described axes of rotation of the rotor masses, can be deliberately omitted in order to further increase the above-described robustness of the MEMS sensor component. Reducing the movable masses on the MEMS sensor component makes it possible to significantly reduce the vibration sensitivity and the mode density.

The present disclosure also relates to a rotation rate sensor comprising a MEMS sensor component according to one of the above-described features and comprising a signal processing unit for applying, receiving and/or processing signals of the MEMS sensor component. The improved MEMS sensor component provides a rotation rate sensor with a particularly robust sensor structure and reduced vibration sensitivity, which is also suitable for applications in environments with high linear and rotational accelerations. The signal processing unit can be regarded as a control and evaluation device of the rotation rate sensor and can, for instance, be configured as an application-specific integrated circuit (ASIC). The signal processing unit can be connected to electrical conductor tracks of the MEMS sensor component, for example by means of a wire bond connection.

In the context of this application, unless explicitly defined otherwise, the words “a/an” are generally not to be understood as a number word, but as indefinite articles meaning “at least one”.

The present disclosure permits a variety of embodiments and is explained in more detail in the following with reference to embodiment examples and the figures.

### BRIEF DESCRIPTION OF THE DRAWINGS

FIG. 1 shows a MEMS sensor component according to a first example embodiment with visualized drive movements in a schematic plan view.

FIG. 2 shows the MEMS sensor component according to FIG. 2 with visualized tilting movements.

FIG. 3 shows the MEMS sensor component according to FIG. 1 with visualized interference movements.

FIG. 4 shows a MEMS sensor component according to a second example embodiment in a schematic plan view.

FIG. 5 shows a schematic diagram of a rotation rate sensor comprising a MEMS sensor component, according to an example embodiment.

### DETAILED DESCRIPTION OF EXAMPLE EMBODIMENTS

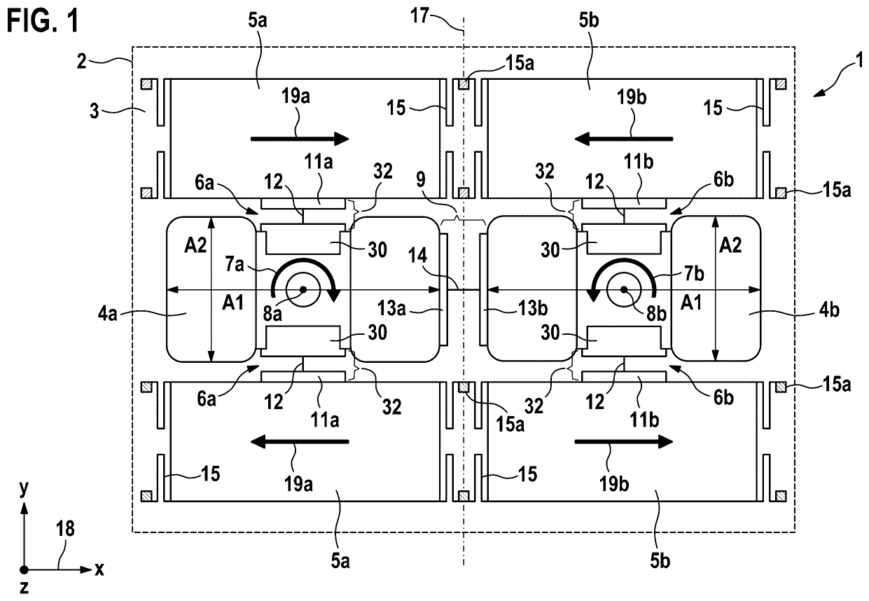

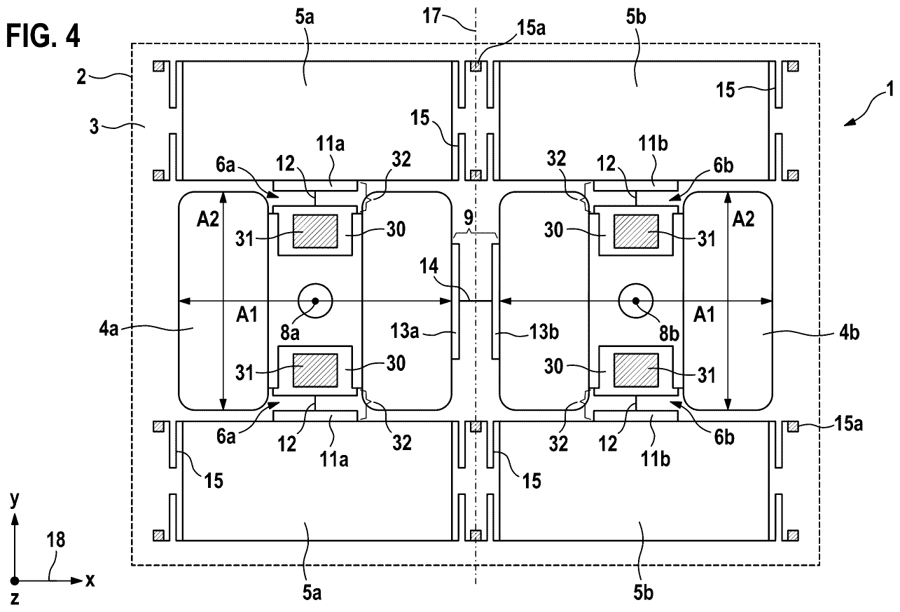

FIG. 1 to 3 each show a schematic illustration of a MEMS sensor component 1 according to a first embodiment in a plan view. Using arrows, FIG. 1 to 3 also show simplified illustrations of drive, tilting and interference movements of components of the MEMS sensor component 1 which are discussed in the following. FIG. 4 shows a MEMS sensor component 1 according to a second embodiment. The three-dimensional spatial directions in FIG. 1 to 4 are assigned to an x-axis, a y-axis and a z-axis according to the additionally shown coordinate system. The MEMS sensor component 1 is configured for direction-dependent acquisition of rotation rates.

FIG. 1 shows that the MEMS sensor component 1 comprises a substrate 2, for example a silicon wafer, with a substrate surface 3. The substrate surface 3 can be described by a plane spanned between the x-and the y-axis. A not further depicted sensor structure of the MEMS sensor component 1 can be disposed on the substrate surface 3 and can, for instance, include electrodes for capacitive acquisition of deflections of movable structures of the MEMS sensor component 1.

According to the shown embodiment example, the MEMS sensor component 1 comprises a first rotor mass 4a and a second rotor mass 4b. The first rotor mass 4a and the second rotor mass 4b are connected to the substrate 2 via not further depicted rotor suspensions which extend in z-direction. The first rotor mass 4a and the second rotor mass 4b are thus limitedly rotatable relative to the substrate surface 3.

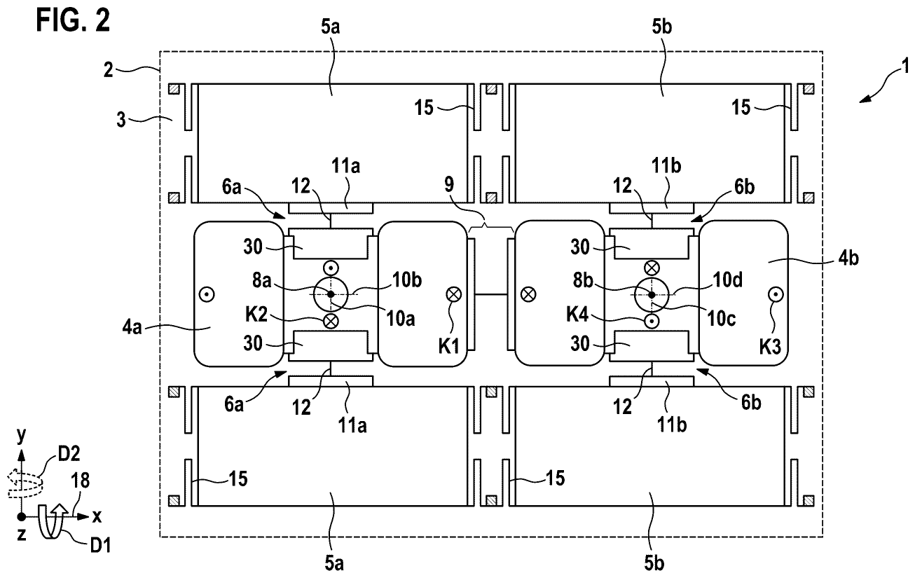

The MEMS sensor component 1 further comprises two first drive elements 5a which are connected to the first rotor mass 4a via first drive coupling structures 6a. The first drive elements 5a are configured to set the first rotor mass 4a into a first rotational oscillating movement 7a about a first axis of rotation 8a oriented perpendicular to the substrate surface 3 with oppositely directed translational first drive movements 19a parallel to the substrate surface 3, as illustrated in FIG. 1. The MEMS sensor component 1 further comprises two second drive elements 5b which are connected to the second rotor mass 4b via second drive coupling structures 6b. The second drive elements 5b are configured to set the second rotor mass 4b into a second rotational oscillating movement 7b about a second axis of rotation 8b oriented perpendicular to the substrate surface 3 with oppositely directed translational second drive movements 19b parallel to the substrate surface 3, as illustrated in FIG. 1. The second axis of rotation 8b extends parallel to the first axis of rotation 8a. The first drive elements 5a and the second drive elements 5b can in particular be controlled with a phase offset in such a way that the first rotor mass 4a and the second rotor mass 4b can be set into oppositely directed rotational oscillating movements 7a, 7b. Coriolis forces enable the rotational oscillating movements 7a, 7b to set the first and the second rotor mass 4a, 4b into a detectable tilting movement K1, K3 visualized in FIG. 2, for instance when a first rotation rate D1 is applied to the MEMS sensor component 1, as will be discussed below. As can further be seen in FIG. 1, the MEMS sensor component 1 also comprises a rotor coupling structure 9 for mechanically coupling the first rotor mass 4a to the second rotor mass 4b in order to compensate manufacturing-related deviations in the tilting movements K1, K3 of the rotor masses 4a, 4b. The rotor coupling structure 9 comprises a first rotor spring bar 13a disposed on the first rotor mass 4a and a second rotor spring bar 13b disposed on the second rotor mass 4b. The first rotor spring bar 13a and the second rotor spring bar 13b are connected to one another by a rotor spring 14. The rotor spring bars 13a, 13b can extend primarily along the y-direction, whereas the rotor spring 14 is oriented along the x-axis.

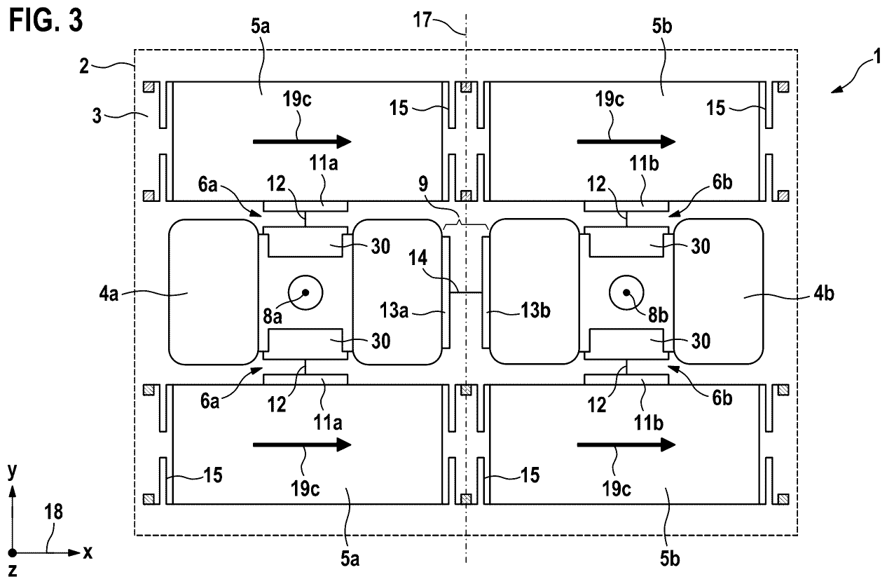

FIG. 2 shows that, according to the shown embodiment example, the first rotor mass 4a and the second rotor mass 4b as well as the first drive coupling structures 6a and the second drive coupling structures 6b are structurally designed to promote a first tilting movement K1 of the first rotor mass 4a about a first tilt axis 10a oriented parallel to the substrate surface 3 and a third tilting movement K3 of the second rotor mass 4b about a third tilt axis 10c oriented parallel to the substrate surface 3, and here also parallel to the first tilt axis 10a, when a first rotation rate D1 is applied to the MEMS sensor component 1 about the x-axis. The first rotor mass 4a and the second rotor mass 4b as well as the first drive coupling structures 6a and the second drive coupling structures 6b are also designed to suppress a second tilting movement K2 of the first rotor mass 4a about a second tilt axis 10b oriented perpendicular to the first tilt axis 10a and a fourth tilting movement K4 of the second rotor mass 4b about a fourth tilt axis 10d oriented perpendicular to the third tilt axis 10c when a second rotation rate D2 is applied to the MEMS sensor component 1 about the y-axis. The MEMS sensor component 1 is consequently particularly robust and, in particular in applications with high external linear and rotational accelerations, it exhibits a comparatively significantly reduced vibration sensitivity. This makes it possible to significantly reduce the mode density of excitation oscillations of the MEMS sensor component 1, and the excitable oscillation modes are at significantly higher frequencies. FIG. 3 shows an example that a parallel drive mode, which is effective at certain frequencies and, as a result of excitation oscillations, leads to parallel interference movements 19c at the drive elements 5a, 5b, does not cause a tilting reaction at the first and the second rotor mass 4a, 4b, which is an advantage over conventional sensor components. In other words, FIG. 3 shows an example of a parallel drive mode in which the drive elements 5a, 5b deflect in the same direction, which can be excited by external linear accelerations. The stiffness of the sensor structure with respect to this oscillation mode and the corresponding frequency of this mode are higher than those of conventional sensor components and represent an advantage over external excitations.

For a corresponding design of the rotor masses 4a, 4b in the manner described above, the rotor masses can, for instance, have a mass distribution that leads to a greater moment of inertia of the rotor mass 4a, 4b under consideration during the first tilting movement K1 and during the third tilting movement K3 and to a lower moment of inertia of the rotor mass 4a, 4b under consideration during the second tilting movement K2 and during the fourth tilting movement K4. For this purpose, as shown in FIGS. 1 to 4, a recess 30 can be provided in the respective rotor mass 4a, 4b, which is disposed closer to the respective drive coupling structure 6a, 6b than to the axis of rotation 8a, 8b. The mass distribution of the rotor masses 4a, 4b can thus be favorably influenced in a structurally simple manner. According to the shown embodiment examples, two recesses 30 are disposed in each of the rotor masses 4a, 4b mirror-symmetrically with respect to the second tilt axis 10b and the fourth tilt axis 10d.

For a corresponding design of the drive coupling structures 6a, 6b in the manner described above, the drive coupling structures can each comprise a spring structure 32 with a direction-dependent different effective spring stiffness, which makes it possible to easily implement different direction-dependent tilting mobilities of the rotor masses 4a, 4b. FIG. 1 shows that the first drive coupling structures 6a and the second drive coupling structures 6b comprise drive spring bars 11a which are disposed on the first and second drive elements 5a, 5b. Second drive spring bars 11b are respectively disposed on the first rotor mass 4a and on the second rotor mass 4b as well. The first drive spring bars 11a and the second drive spring bars 11b are each connected to one another by a drive spring 12. The drive spring bars 11a, 11b provide a robust coupling of the drive elements 5a, 5b to the rotor masses 4a, 4b, which can promote a direction-dependent different mobility of the rotor masses 4a, 4b. As shown in FIG. 1, the drive spring bars 11a, 11b have a main extension direction in x-direction, whereas the drive spring 12 extends perpendicular to that in y-direction.

The MEMS sensor component 1 is configured to detect a rotation rate D1 being applied to the MEMS sensor component 1 about a detection axis 18 as illustrated in FIG. 2. According to the shown embodiment example, the number of detection axes 18 of the MEMS sensor component 1 is structurally limited to exactly one detection axis 18, here the x-axis. The structural limitation is achieved by restricting the mechanical degrees of freedom of movement of the rotor masses 4a, 4b, which can be realized via a corresponding design of the rotor masses 4a, 4b and the drive coupling structures 6a, 6b. The inclusion of movable sensor masses for detecting rotation rates about the z-axis has moreover been omitted.

The use of two rotor masses 4a, 4b makes it possible to achieve an advantageous compensation function, because external influences affect both rotor masses 4a, 4b equally and can therefore be canceled out via signals within the framework of a differential evaluation. The first rotor mass 4a and the second rotor mass 4b are mounted one behind the other along the shown x-direction. The first tilt axis 10a and the third tilt axis 10c extend in y-direction, i.e. perpendicular to the x-direction, and parallel to the substrate surface 3. The first drive elements 5a and the first rotor mass 4a are furthermore mounted one behind the other along the y-direction. The second drive elements 5b and the second rotor mass 4b are likewise mounted one behind the other along the y-direction. The described arrangement of the drive elements 5a, 5b and the rotor masses 4a, 4b relative to one another creates a compact and robust arrangement with which a favorable mechanical coupling with easily adjustable restriction of mobility to the rotor masses 4a, 4b can be achieved. FIG. 1 shows that the first rotor mass 4a and the second rotor mass 4b each have a maximum extent A2 in the second spatial direction y that corresponds to at most 75% of a maximum extent Al of the same rotor mass 4a, 4b in the first spatial direction x. The rotor masses 4a, 4b thus, in simplified terms, have an approximately rectangular basic shape, which influences the moment of inertia of the rotor masses 4a, 4b in the desired manner such that the first tilting movement K1 and the third tilting movement K3 are promoted, while the second tilting movement K2 and the fourth tilting movement K4 are suppressed.

FIG. 1 also shows that the first drive elements 5a and the second drive elements 5b are each connected to the substrate 2 via meander-shaped deflecting springs 15 with direction-dependent different effective spring stiffnesses. The deflecting springs 15 are attached to the substrate 2 via anchor elements 15a. The deflecting springs 15 are shaped such that there is a high degree of mobility of the connected drive element 5a, 5b parallel to the second tilt axis 10b or the fourth tilt axis 10d and a relatively lower degree of mobility of the connected drive element 5a, 5b parallel to the first tilt axis 10a or the third tilt axis 10c is implemented. The direction-dependent tilting mobility of the rotor masses 4a, 4b can thus be further supported.

In addition to the depicted drive movements 19a, 19b and the resulting rotational oscillating movements 7a, 7b, FIG. 1 also shows that the MEMS sensor component 1 has a mirror-symmetrical structure with respect to an axis of symmetry 17 which extends parallel to the first and the third tilt axis 10a, 10c through the rotor coupling structure 9. The mirror-symmetrical structure makes it possible to improve the mutual cancellation of external influences on the rotor masses 4a, 4b and increase the measurement accuracy of the MEMS sensor component 1.

FIG. 4 shows a MEMS sensor component 1 according to a second embodiment that is substantially comparable to the first embodiment in terms of structure and functioning. The figure also shows that stop elements 31 extend through the recesses 30 in the rotor masses 4a, 4b parallel to the first axis of rotation 8a of the first rotor mass 4a and parallel to the second axis of rotation 8b of the second rotor mass 4b, which advantageously makes it possible to limit the rotational oscillating movements 7a, 7b of the rotor masses 4a, 4b. Unlike the rotor masses 4a, 4b of the MEMS sensor component 1 according to the first embodiment, the rotor masses 4a, 4b in the second embodiment are dimensioned such that the rotor masses 4a, 4b each have a maximum extent A2 in the second spatial direction y that corresponds to at least 75% of a maximum extent A1 of the same rotor mass 4a, 4b in the first spatial direction x, which provides a stable configuration of the rotor masses 4a, 4b.

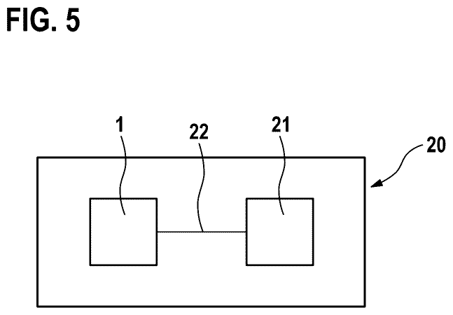

FIG. 5 shows a schematic diagram of a rotation rate sensor 20 comprising a MEMS sensor component 1, which can be configured according to one of the embodiment examples discussed with reference to FIG. 1 to 4, for instance, and comprising a signal processing unit 21 for applying, receiving and/or processing signals of the MEMS sensor component 1. The MEMS sensor component 1 and the signal processing unit 21 are electrically connected to one another via a signal connection 22, which can be configured as a wire bond connection, for example. Because of the improved MEMS sensor component 1, the rotation rate sensor 20 exhibits reduced vibration sensitivity with a reduced mode density and is generally suitable for use in environments with high linear and rotational accelerations without additional damping components.

1-15. (canceled)

16. A microelectromechanical system (MEMS) sensor component, comprising:
a substrate having a substrate surface;
a first rotor mass; and
two first drive elements which are connected to the first rotor mass via first drive coupling structures and are configured to set the first rotor mass into a first rotational oscillating movement about a first axis of rotation oriented perpendicular to the substrate surface;
wherein, when a rotation rate is applied to the MEMS sensor component, the first rotor mass and/or the first drive coupling structures are configured to:
promote a first tilting movement of the first rotor mass about a first tilt axis oriented parallel to the substrate surface, and
suppress a second tilting movement of the first rotor mass about a second tilt axis oriented perpendicular to the first tilt axis.

17. The MEMS sensor component according to claim 16, further comprising:
a second rotor mass; and
two second drive elements which are connected to the second rotor mass via second drive coupling structures and are configured to set the second rotor mass into a second rotational oscillating movement about a second axis of rotation oriented perpendicular to the substrate surface;
wherein, when the rotation rate is applied to the MEMS sensor component, the second rotor mass and/or the second drive coupling structures are configured to:
promote a third tilting movement of the second rotor mass about a third tilt axis oriented parallel to the substrate surface, and
suppress a fourth tilting movement of the second rotor mass about a fourth tilt axis oriented perpendicular to the third tilt axis.

18. The MEMS sensor component according to claim 17, further comprising:
a rotor coupling structure mechanically coupling the first rotor mass to the second rotor mass.

19. The MEMS sensor component according to claim 17, wherein at least one of: (i) the first rotor mass has a mass distribution such that the first rotor mass has a greater moment of inertia during the first tilting movement than during the second tilting movement, or (ii) the second rotor mass has a mass distribution such that the second rotor mass has a greater moment of inertia during the third tilting movement than during the fourth tilting movement.

20. The MEMS sensor component according to claim 19, wherein at least one of: (i) the first rotor mass includes a recess which is disposed closer to a first drive coupling structure than to the first axis of rotation, or (ii) the second rotor mass includes a recess which is disposed closer to a second drive coupling structure than to the second axis of rotation.

21. The MEMS sensor component according to claim 20, wherein at least one of: (i) the first rotor mass includes at least two recesses which are disposed mirror-symmetrically with respect to the second tilt axis, or (ii) the second rotor mass includes at least two recesses which are disposed mirror-symmetrically with respect to the fourth tilt axis.

22. The MEMS sensor component according to claim 20, wherein a stop element extends through the recess in the first rotor mass or through the recess in the second rotor mass parallel to the first axis of rotation of the first rotor mass and/or parallel to the second axis of rotation of the second rotor mass.

23. The MEMS sensor component according to claim 17, wherein the first drive coupling structures and/or the second drive coupling structures include a spring structure with a direction-dependent different effective spring stiffness.

24. The MEMS sensor component according to claim 17, wherein at least one of: (i) the first drive coupling structures include first drive spring bars which are disposed on the first drive elements and are connected to the first rotor mass via a drive spring, or the second drive coupling structures include second drive spring bars which are disposed on the second drive elements and are connected to the second rotor mass via a drive spring.

25. The MEMS sensor component according to claim 17, wherein the first rotor mass and the second rotor mass are mounted one behind the other along a first spatial direction, and wherein the first tilt axis and the third tilt axis extend perpendicular to the first spatial direction and parallel to the substrate surface.

26. The MEMS sensor component according to claim 17, wherein the first drive elements and the first rotor mass are mounted one behind the other along a second spatial direction, and wherein the second drive elements and the second rotor mass are mounted one behind the other along the second spatial direction, wherein the second spatial direction extends perpendicular to the first spatial direction and parallel to the substrate surface.

27. The MEMS sensor component according to claim 17, wherein each rotor mass of the first rotor mass and/or the second rotor mass has a maximum extent in the second spatial direction that corresponds to at least 75% of a maximum extent of the rotor mass in the first spatial direction.

28. The MEMS sensor component according to claim 17, wherein each rotor mass of the first rotor mass and/or the second rotor mass has a maximum extent in the second spatial direction that corresponds to at most 75% of a maximum extent of the rotor mass in the first spatial direction.

29. The MEMS sensor component according to claim 16, wherein the MEMS sensor component is configured to detect a rotation rate being applied to the MEMS sensor component about a detection axis, and wherein a number of detection axes of the MEMS sensor component is structurally limited to exactly one detection axis.

30. A rotation rate sensor, comprising:
a microelectromechanical system (MEMS) sensor component; and
a signal processing unit for at least one of: applying, receiving or processing signals of the MEMS sensor component;
wherein the MEMS sensor component includes:
a substrate having a substrate surface,
a first rotor mass, and
two first drive elements which are connected to the first rotor mass via first drive coupling structures and are configured to set the first rotor mass into a first rotational oscillating movement about a first axis of rotation oriented perpendicular to the substrate surface;
wherein, when a rotation rate is applied to the MEMS sensor component, the first rotor mass and/or the first drive coupling structures are configured to:
promote a first tilting movement of the first rotor mass about a first tilt axis oriented parallel to the substrate surface, and
suppress a second tilting movement of the first rotor mass about a second tilt axis oriented perpendicular to the first tilt axis.
